(19) United States
(12) Patent Application Publication
(10) Pub. No.: US 2017/0101192 A1
(43) Pub. Date: Apr. 13, 2017

(54) Smart Electronic Location Flare

(71) Applicants: Richard Lawrence Maguire, Salisbury (GB); Daniel Locke, Penarth (GB)

(72) Inventors: Richard Lawrence Maguire, Salisbury (GB); Daniel Locke, Penarth (GB)

(21) Appl. No.: 14/880,391

(22) Filed: Oct. 12, 2015

(51) Int. Cl. B64D 45/00; G01S 19/13

(52) U.S. Cl. CPC B64D 45/00; G01S 19/13; B64D 2045/0065

(57) ABSTRACT

A smart electronic location flare is formed of an assembly of power source, self-contained activation switch, computer processor, and satellite communication device. The unit components are all housed inside a double-skinned, thermally insulated, sealed container. The unit is constructed such that it may be located throughout an aircraft's structure, condition activated, withstand impact with water at its own terminal velocity, remain floating and regularly transmit geo-location data concerning its location.

This invention relates to a condition-activated device for communicating location data.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING ETC.

Not Applicable

### BACKGROUND OF THE INVENTION

When an aircraft catastrophically breaks up over or into the sea, the aircraft's Flight Data Recorder is usually located and recovered to evaluate the details relating to the accident event. The Flight Data Recorder has its own location beacon that transmits a frequency signal, acting as an electronic flare to assist the searchers.

However, the Flight Data Recorder is usually attached to the inside the aircraft and often sinks to the sea floor. The attenuation of radio signals from the Flight Data Recorder transmitter through water is poor and often the signal is not heard or the battery power for the signal becomes exhausted before a location fix has been obtained. Research has shown that one in ten flight data recorders fail to operate or are lost.

Prior art location beacons that are attached to flight data recorders are necessarily connected to the aircraft data and instrument systems such that they can continually record the flight data and sound recordings. The value and extent of the data also means that the flight data recorder has to be protected from the effects of a catastrophic event such as a fuel fire, or a high-speed impact leading to very high deceleration forces upon the structure. In addition, as they are connected to aircraft systems, they are vulnerable to being tampered with during their operation, sometimes leading to failure.

However, the present invention overcomes these limiting requirements by concentrating on providing smart location data of the crash site and the existing flight data recorders within in an electronic flare function. This location data is obtained from a satellite communication sequence that is then emailed directly to the emergency service and the aircraft owners. With location data provided this way, the smart electronic location flare does not have to be attached to the aircraft's systems, hence it may be loosely held and positioned in multiple locations inside or outside the pressure hull of the aircraft and be condition activated based on the nature of aircraft failures.

Prior art electronic beacons did not necessarily provide for protection of the electronics and functions of the beacon. The invention uses its container to provide thermal, pressure, water and impact protection to the electronics. The container has a buoyancy lid sufficient enough to provide an extended time floating in seawater with line of sight to a communications satellite.

Prior art utilises externally sourced activation methods; activation of the invention may be accomplished by means of one or several of the following self-contained methods; an internal accelerometer switch, internal magnetic reed switch; as well as remote electronic signals, removal of a physical pin, or by insertion into water. Activation may take place because of physical separation from the aircraft structure or due to an impact force that is characteristic of a catastrophic aircraft failure that would usually require the attention of the emergency services.

Prior art utilises a radio frequency transmission to assist a search and location effort, whereby the radio frequency signal is tracked to allow a specific location to be determined The invention exchanges communications with a global satellite provision and then emails or texts the geolocation coordinates of its position to a series of pre-determined addresses or numbers.

### BRIEF SUMMARY OF THE INVENTION

A smart electronic location flare, unit 1, is formed of an assembly of power source 2, activation switch 3, computer processor 4, and satellite communication device 5. The unit components are housed inside a double-skinned, thermally insulated, sealed container. The unit is constructed such that it will be condition activated, withstand impact with water, remain floating and regularly transmit email and or text data concerning its location.

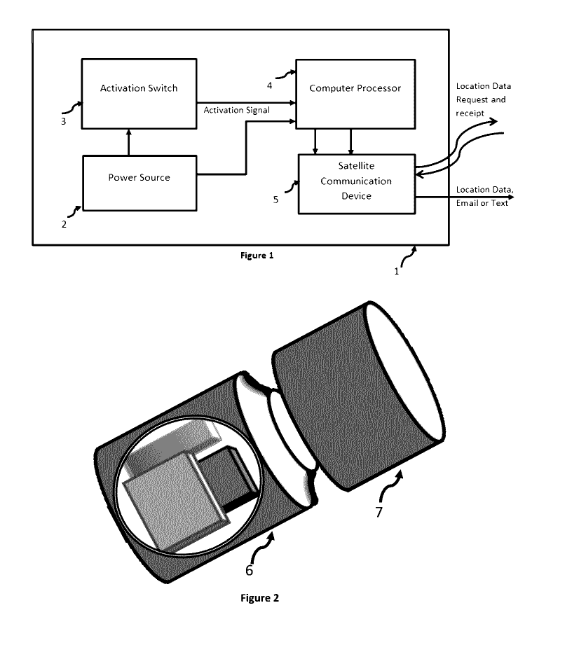

FIG. 1 shows the smart electronic location flare, unit 1, being formed of an assembly of a power source 2, activation switch 3, computer processor 4 and a satellite communication device 5.

FIG. 2 shows the unit components being housed inside a double-skinned, thermally insulated, sealed container 6 with closure buoyancy lid 7.

### DETAILED DESCRIPTION OF THE INVENTION

A smart electronic location flare is formed through the electrical connection of power source 2, self-contained activation switch 3, computer processor 4, and satellite communication device 5. The unit components are all housed inside a double-skinned, thermally insulated, sealed container. The unit is constructed such that it will remain passive within an aircraft structure and be condition activated upon a catastrophic failure of the aircraft. This event will cause an activation signal to be sent to the computer processor 4 and the satellite communication device 5. The invention can withstand impact with water at its own terminal velocity, remain floating and regularly transmit geo-location data concerning its location.

The invention may be placed throughout an aircraft and remain able to function after being exposed to variations in temperature and pressure. This is accomplished by means of a double skin insulation and protection container that is sealed but flexible enough to allow for impact absorption. The container is coloured in a luminescent colour and printed with appropriate text to describe its function.

Upon receiving the activation signal, the communication device exchanges communication messages with a satellite system, and resends its own geo-location coordinates via email and or text to a series of pre-set addresses. These exchange and send functions are repeated at pre-set time intervals until the power source degrades.

1. A smart electronic location flare unit comprising a power source, activation switch, computer processor and satellite communication device electronically connected together, is housed inside a floating, double-skinned, thermally insulated, impact resistant, sealed container.

2. A smart electronic location flare according to claim 1, in which the communications device is activated by accelerometers.

3. A smart electronic location flare according to claim 1, in which the communications device is activated by a reed switch.

4. A smart electronic location flare according to claim 1, in which the communications device is activated by insertion in water.

5. A smart electronic location flare according to claim 1, in which the communications device is activated by Local Area Network (LAN) communications from the aircraft system.

6. A smart electronic location flare according to claim 1, in which the communications device is activated by removal of a physical obstruction.

7. A smart electronic location flare according to claim 1, in which the power source comprises a photo-voltaic or solar cell.

8. A smart electronic location flare according to claim 1, in which the communications device transmits its own geo-location coordinates.
